(19) United States
(12) Patent Application Publication
(10) Pub. No.: US 2013/0196838 A1
(43) Pub. Date: Aug. 1, 2013

(54) Open-End Shaped Retaining Device of Tubular Material Packaging

(71) Applicant: Weilong Cao, Shanghai (CN)

(72) Inventor: Weilong Cao, Shanghai (CN)

(21) Appl. No.: 13/824,957

(22) PCT Filed: Mar. 2, 2012
(86) PCT No.: PCT/CN12/71895

§ 371 Date: Mar. 18, 2013

(30) Foreign Application Priority Data
Aug. 26, 2011 (CN) 201110247831.5

(51) Int. Cl. B31B 19/74

(52) U.S. Cl. CPC B31B 19/74
USPC 493/186

(57) ABSTRACT

The present invention relates to an open-end shaped retaining device for tubular material packaging, and more particularly relates to a packaging device for pillow-type packaging. Compared with other pillow-type packaging for tubular material, the existing pillow-type packaging method for flaky materials has the disadvantage of wasting material which affects appearance, increases the price, adds additional working procedures, increases energy consumption, and raises labor costs. The present invention provides an open-end shaped retaining device for tubular material packaging in which an internal support pit is arranged on an inner support seat. Each internal support pit has an opening at the top and a channel at the bottom. Each of the tubular materials has an opening that penetrates from the bottom channel to the top of the internal support pit. The internal support pit is arranged on one of the tubular materials, wherein each internal support pit with an opening at the top is parked in one of the inner support seats, and the lower part of the internal support pit is provided with a magnetic object. The external shape of the lower part of the internal support pit is specially shaped, and the inner support pit is similarly specially shaped to provide for this magnetic object. The open-end shaped retaining device is used for the pillow-type automatic packaging machine of tubular material.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a pillow-type packaging machine, more particularly relates to a packaging method for tubular material.

2. Description of Related Arts

Pillow-type packaging methods of the prior art are to seal both sides of a flat material along the longitudinal direction to form a cavity, and then put object to be packed is put into this cavity. The shape of a well packaged object looks like a pillow, and so named as a pillow-type packaging. The entire packaging process has a high degree of automation at a fast speed which is suitable for bulk, granular, powder, or liquid objects such as biscuits, pies, chocolates, breads, instant noodles, the traditional Chinese food “moon cake”, soybean milk, milk, soy sauce, cooking wines, or arrowroot flour. All these products can in turn be used for all kinds of daily necessities, industrial parts, medical devices and the like. A number of patents and conventional technologies associated with the pillow-type packaging machine have been disclosed.

It is expected that the pillow-type packaging method intends to seal flaky materials to form a cavity-like structure, all the while putting the objects being packed into the cavity for packaging; however, this kind of packaging has the following disadvantages: 1. wasting materials such that the conventional pillow-type packaging machine provided to package objects after sewing both sides of the flaky material, wherein the sewn part needs a considerable number of packaging materials; 2. influencing the appearance such that the seams remaining and stacked outside the packaging bag impact the appearance of the packaging bag; 3. the expensive cost such that in the forming process multilayer composite materials required to make the package have a high cost; 4. adding extra procedures such that the processing steps for making a pillow-type flaky material packaging are increased, and thus the energy consumption and labor costs are increased as well relative to the tubular material packaging.

Compared with the flaky material packaging process, the packaging process using a tubular material does not need multilayer composite materials, and does not generate an intermediate suture portion. Accordingly, the advantages of the packing process using a tubular material are a beautiful appearance, energy saving, and a lower cost.

Furthermore, there are considerable differences in the packaging procedure if comparing tubular material packaging with flaky material packaging: 1. for the feeding process of a flaky packaging, the packaged object is involved with the flaky material therein so that it is not necessary to think of creating an open-end, but for the feeding process of a tubular material packaging, the packaged object has to be put into the tubular material from the newly formed open-end which has to be retained in a opened state. The packaging shape is capable of being irregularly shaped, the opened open-end shape has to be matched with the shape of packaging object. For example, matching the round shape to the round shape, the square shape to the square shape, the rectangular shape to the rectangular shape, the irregularly shaped to the irregularly shaped.

Furthermore, there are considerable differences in the feeding procedure if comparing tubular material packaging with flaky material packaging: 1. for feeding process of a flaky packaging, the packed object is involved into the flaky material therein so that it is not necessary to think of creating an open-end, but for feeding process of a tubular material packaging, since the root of the tubular material has an open-end the packaged object has to be put into the tubular material from the open-end before the completion of the previous package, and the open-end of the next package has to be formed and has to be retained in a opened state. Considering the flaky packaging material type, as long as just one piece is moving, the packaging speed is capable of being satisfied as requested, whereas a tubular material packaging type needs that at least four packing material to be formed simultaneously so as to meet the requirements for packaging speed. This forms the problems of how to complete multiple packaging bags and form multiple open-ends simultaneously.

Although a method using a pneumatic claw support is proposed in the Chinese patent application (CN200820162608) which disclosed “an orifice opening device of packing bag of automatic packaging machine for a disposable injector”, it forms the problem that there is no explanation of how to ensure that an irregularly shaped open-end is always retained in an opened state.

There is not a relatively well developed technology for the prior art which makes the newly formed open-end of the tubular able to retain a specified shape. Accordingly, it is impossible to make an automated production assembly-line, such that the working efficiency of the manual operation process used for opening the orifice of the tubular material packaging is poor; it also impossible to meet the packaging requirements of items with a high hygiene requirement.

### SUMMARY OF THE PRESENT INVENTION

The present invention is to provide an open-end shape retaining device for tubular material packaging in which the open-end is always opened with a specified shape for tubular material packaging.

The present invention is to provide a proposed solution for preparing an object with a diameter no greater than the inner diameter of the opened tubular material, wherein the top-end shape of the object is to be a specified shape, wherein the object is then placed into the tubular material with a vertical shape. As long as the open-end position is retained at top part of the object, the shape of the open-end is bound to be a specified shape as required because the open-end tubular material is soft and malleable

In order to adjust the open-end to reach its top-end position, the object has to be parked upward at a position where the tubular material is capable of moving downward. It is now possible to satisfy the requirement for adjusting the open-end position.

Taking into account that the open-end needs to be always retained the same irregular shape, it is possible to design the lower portion of the object to be a special-shaped shape, while the parked position is also designed to be the same special-shaped shape, so that the object is always in a unique posture parked at this position. The preceding makes it possible to satisfy the requirement of achieving an always open retaining open-end at the same posture.

In an aspect of the present invention, a row of the inner supports are arranged on the vacant inner support seat, wherein the shape of inner support with an upward orifice is specially-shaped, and there is a magnetic object in the inner support pit; additionally, each of the inner support pits has a channel where the tubular material may pass through.

Coiled-shaped tubular material, regulator and detector are under inner support. Each of coiled-shaped tubular material is under the control of the regulator, of which is capable of being pulled backward; a label which may be recognized by a detector is printed on the tubular material, the operation of the regulator is under the instruction of the detector. Each of tubular material with an upward open-end penetrates from a channel of the inner support pit through the upper inner support pit.

All of the top-ends of inner support are made a specified shape in accordance with the requirements of the packaging, and the shape of the lower part of the inner support pit is specially-shaped contrary to that of inner support pit. There is a magnetic object in lower part of the inner support, of which has an opposite polarity to that of the inner support pit. Each of the inner supports with an upward top-end is within a tubular material, and parked in a inner support pit.

During operation, since the specially-shaped lower portion of the inner support and the inner support pit are contrary and constrained by the magnetic objects, each of the inner supports may only be parked throughout in the inner support pit by the same posture; meanwhile, the detector may instruct a regulator to pull the tubular material backward according to the label on the tubular material. Since the inner cross-sectional area is greater than that of the channel, the inner support is not capable of moving when the tubular material is moved backward. As long as the location of the label is already calculated or identified, the open-end will always be remain at the top-end position of the inner support; that is, the open-end will always remain the same specified shape.

The present invention is implemented by providing an open-end shape retaining device for tubular material packaging comprising; an inner support (10), an inner support seat (20), an inner support pit (21), a regulator (30), a detector (31), a tubular material (40), a label (42) printed on said tubular material (40) for detection, wherein said tubular material (40) is coil-shaped, wherein said detector (31) is capable of detecting said label (42) on said tubular material (40) , wherein said regulator (30) is capable of removing said tubular material (40), wherein said detector (31) is connected with said regulator (30), wherein the detector (31) is capable of instructing said regulator (30) to move or stop, and the transverse cross-sectional shape of said inner support top (11) is similar to the shape of packaging object, wherein said present invention is characterized in that said regulator (30), said detector (31), a coil-shaped tubular material (43) are situated below said inner support pit (21), wherein all of said inner support pits (21) are situated on said inner support seat (20) with an upward opening orifice respectively, wherein one channel is configured on each bottom of said inner support pits (21),wherein each open-end (41) of said tubular material (40) are situated over said inner support pit (21), wherein one of said inner support (10) is within one of said tubular material (40), wherein each of said inner support (10) stays in a said inner support pit (21) with the upward top-end of the inner support (11), wherein each inner support (10) is located in said inner supporting top (11) and parked upwardly into said inner support pit (21), wherein the lower part of has said inner support has a magnetic object (23) and the external shape of the lower part of said inner support (10) is specially-shaped, wherein the shape of said inner support pits (21) are specially-shaped and a magnetic object (23) is configured therein.

According to another feature of the invention, the inner support pits (21) are preferably arranged in a column on said inner support seat.

According to a further feature of the invention, the external shape of the lower part of said inner support (10) is preferably the same as the shape of said inner support pit (23), and the polarity of said magnetic object (23) of said inner supporting (10) is opposite to the polarity of said magnetic object (23) of said inner support pit (23).

According to still yet another feature of the invention, said open-end (41) is preferably positioned at the top-end of said inner supporting (11).

According to a still yet another feature of the invention, all of the distances between the adjacent labels (42) are preferably the same.

Accordingly, the advantages obtained by the invention are such that an open-end opened by the inner support is placed into the tubular material, which is in a flat and closed state. The method according to the present invention is simple and reliable, and the cost for making the inner supports is rather low. The inner supports can be made at anytime based on different packaged objects, but the shape of the open-end opened by the inner support is the same.

### BRIEF DESCRIPTION OF THE DRAWINGS

FIG. 1 is a schematic side view of the initial state of an example.

FIGS. 2 is a schematic side view of the operating state of the example.

The drawing symbols are described as follows: 10: inner support; 11: top-end of inner support; 12: lower part of inner support; 20: inner support seat; 21: inner support pit; 22: channel; 23: magnetic object; 30: regulator; 31: detector; 40: tubular material; 41: open-end; 42: label; 43: coil-shaped tubular material.

The examples hereinafter described in the following drawings have multiple inner supports, indicating that the number of the packaged units according to present invention is not only limited to five, but can be greater or less than five.

The operation of each member in the examples can be completed by selecting electric or pneumatic member, but for the purpose of a simple illustration, the power supply and the motive power will not be described hereinafter and in the drawings.

### DETAILED DESCRIPTION OF THE PREFERRED EMBODIMENT

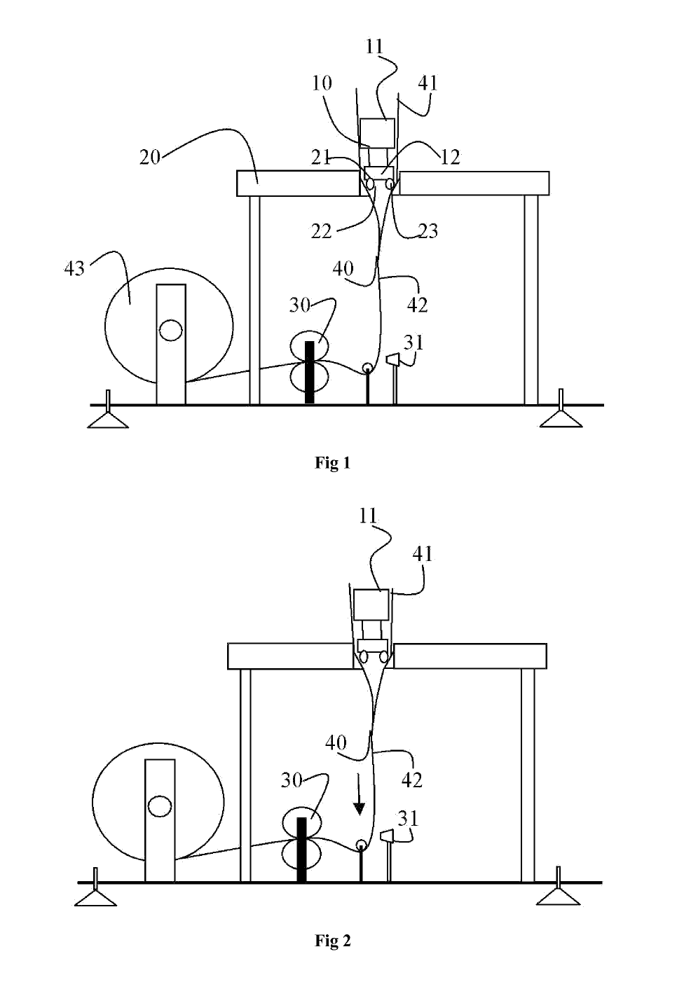

Referring to FIG. 1, which is a partially enlarged schematic sectional side view of the initial state of an example of the present invention.

In respect to the side view, an initial state pattern of a packaging bag formed by tubular material is shown in the figure.

The tubular material 40 is printed with a detectable label 42 thereon and is coil-shaped, wherein the coil-shaped tubular material 43 is below an inner support pit 21, and all of the distances between the two adjacent labels 42 are equal. The exact length of the distance between the two adjacent labels 42 is determined by the length of packaging object accordingly. The open-end 41 of the tubular material 40 is horizontally pulled out from the coil-shaped tubular material 43. The detector 31 is beside the pulled-out of tubular material 40, and is capable of detecting the label 42 on the tubular material 40. The detector 31 is connected with the regulator 30 and moves downward from the tubular material 40. When the detector 31 detects the label 42 it instructs the regulator 30 to stop moving the tubular material 40.

The inner support pits 21 on the inner support seat 20 are arranged in a column and have an upward orifice. Each bottom of the inner support pits 21 has a channel 22, and the shape of this inner support pit 21 is specially-shaped for having a magnetic object 23 therein.

The transverse sectional shape of the top-end of the inner support 11 is similar to the shape of a object being packaged; wherein the lower part of the inner support 10 has magnetic object 23 and the external shape of the lower part of the inner support 10 is specially-shaped. The external shape of the lower part of the inner support 10 is specially-shaped the same as the shape of an inner support pit, and the polarity of the magnetic object 23 of the inner support 10 is opposite to the polarity of magnetic object 23 of the inner support pit 23.

The open-end 41 of the tubular material 40 reaches upward over the inner support pit 21 via the channel 22; in other words, each open-end 41 of the tubular material 40 is over the inner support pit 21, and the inner support 10 is inside the open-end 41 of the tubular material 40, wherein the open-end 41 is positioned at the top-end of the inner support 10.

An inner support 10 is placed on the inner support pit 21. An inner support 10 is within the tubular material 40, and each of the inner support 10 stay in the inner hole 21 with the upward top-end of the inner support 11. The purpose of designing the shape of lower part of the inner support pit 21 and inner support 10 into a special-shaped is to make the inner support 10, which stays on inner support pit 21, capable of always retaining the same state. The magnetic object 23 is to ensure that the inner support 10 can be always retained in the same state.

Referring to FIG. 2, which is a schematic diagram for adjusting the open-end position of the example.

Because the shape of the transverse cross-sectional area of the inner support top 11 is similar to the shape of the object being packaged, if is it intended to make the shape of the top-end 41 of the tubular material 40 into a similar shape of the object being packaged, then the position of the open-end 41 of the tubular material 40 has to be adjusted at the position of a top-end of the inner support 11.

According to the adjusting method, the purpose of the regulator 30 is to make the tubular material 40 be downwardly removed, and the for the detector 31 to detect label 42 on the tubular material 40. When the label 42 is detected, regulator 30 stops the tubular material 40 from moving, and the open-end 41 is positioned at the top-end of the inner support 11.

What is claimed is:

1. An open-end shape retaining device for tubular material packaging, comprising:
an inner support (10), an inner support seat (20), an inner support pit (21), a regulator (30), a detector (31), a tubular material (40), and a label (42) printed on said tubular material (40) for detection, wherein said tubular material (40) is coil-shaped, wherein said detector (31) is capable of detecting said label (42) on said tubular material (40), wherein said regulator (30) is capable of moving said tubular material (40), wherein said detector (31) is connected with said regulator (30), wherein the detector (31) is capable of instructing said regulator (30) to move or stop, wherein the transverse cross-sectional shape of said inner support top (11) is similar to the shape of a packaging object, wherein said regulator (30), said detector (30) and said coil-shaped tubular material (43) are situated below said inner support pit (21), wherein all of said inner support pits (21) are situated on said inner support seat (20) with an upward opening orifice respectively, wherein one channel is configured in each bottom of said inner support pits (21), wherein each open-end (41) of said tubular material (40) situated over said inner support pit (21), wherein one of said inner support (10) is within one of said tubular material (40), wherein each of said inner support (10) stays in said inner support pit (21) with an upward end of said inner support top (11), wherein each inner support (10) is located in said inner support top (11) and stays upward into said inner support pit (21), wherein the lower part of said inner support (10) has a magnetic object (23), wherein the external shape of the lower part of said inner support (10) is specially-shaped, wherein the shape of said inner support pits (21) are specially-shaped and said magnetic object (23) is configured therein.

2. An open-end shape retaining device for tubular material packaging, according to claim 1, wherein said inner support pits (21) are arranged in a column on said inner support seat (20).

3. An open-end shape retaining device of tubular material packaging, according to claim 1, wherein the external shape of the lower part of said inner support (10) is the same as the shape of said inner support pit (21), and the polarity of said magnetic object (23) of said inner support (10) is opposite to the polarity of said magnetic object (23) of said inner support pit (21).

4. An open-end shape retaining device of tubular material packaging, according to claim 1, wherein said open-end (41) is positioned at the top-end of said inner support (11).

5. An open-end shape retaining device of tubular material packaging, according to claim 1, wherein all of the distances between the adjacent labels (42) are the same.
